(19) United States
(12) Patent Application Publication
(10) Pub. No.: US 2010/0154040 A1
(43) Pub. Date: Jun. 17, 2010

(54) METHOD, APPARATUS AND SYSTEM FOR DISTRIBUTED DELEGATION AND VERIFICATION

(75) Inventor: Chuan-Feng CHiu, Taiwan (CN)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/377,053

(22) PCT Filed: Feb. 29, 2008
(86) PCT No.: PCT/JP2008/054103

§ 371 Date: Feb. 10, 2009

(30) Foreign Application Priority Data
Mar. 5, 2007 (CN) 200710085459.6

(51) Int. Cl. H04L 29/06; H04L 12/22

(52) U.S. Cl. 726/5

(57) ABSTRACT

A method for distributed delegation and verification includes: a service provider generating first delegation information including authorization credentials and self-signed credentials thereof to establish a delegation relationship with a first service node; the first service node generating second delegation information including the authorization credentials in the first delegation information and self-signed credentials thereof to establish a delegation relationship with a service requestor; upon receipt from the service requestor of a service request including the delegation information issued to the service requestor, the service provider requesting the first service node to verify the self-signed credentials in the delegation information in the service request; the first service node performing verification; and upon successful verification by the first service node, the service provider verifying the authorization credentials in the delegation information in the service request and, upon successful verification, granting the service request.

### TECHNICAL FIELD

The invention relates to a method, apparatus and system for delegation and verification, and more particularly to a method, apparatus and system for distributed delegation and verification.

### BACKGROUND ART

With the increasing popularity of networks, a service requestor can use services provided by innumerable service providers through the networks. In order to enable a device to conduct secure service sharing with other devices, a device serving as the service provider will carry out delegation with respect to some other devices, and these other devices in turn can carry out delegation with respect to other devices, so that all the delegated devices can be service requestors and use the services provided by the service provider. In this case, the delegation relationships among all the devices can be directly managed by a central server in a centralized way.

However, under certain circumstances (e.g., in a restricted network environment), since not all the devices can access the central server, this service sharing cannot be conducted. Therefore, under such circumstances, the use of decentralized management is required.

Referring to FIG. 1, U.S. Patent Application Publication No. 20020073308 disclosed a method for managing attribute certificates. The method is suitable for use in a system including a service provider 11, a service requestor 12, and a database 13. The service provider 11 is a delegator. The service requestor 12 is a delegatee, and has an attribute certificate 16. The database 13 stores a public key certificate 17 of the service requestor 12, and a public key certificate 18 of an authority issuing the attribute certificate 16.

The service provider 11 receives the attribute certificate 16 from the service requestor 12, and extracts a public key certificate locator 161 from the attribute certificate 16. The public key certificate locator 161 identifies the locations of the public key certificate 17 of the service requestor 12 and the public key certificate 18 of the authority issuing the attribute certificate 16. The service provider 11 utilizes the public key certificate locator 161 to extract the public key certificate 17 of the service requestor 12 and the public key certificate 18 of the authority issuing the attribute certificate 16 from the database 13, and utilizes the extracted public key certificates 17, 18 to verify the attribute certificate 16. Upon successful verification, the service provider 11 allows the service requestor 12 to access controlled resources according to an authorization attribute stored in the attribute certificate 16.

If the system further includes at least one service node (not shown) having an attribute certificate so that the service provider 11 is a source delegator, the service requestor 12 is a destination delegatee, and the service node serves first as an intermediary delegatee and then as an intermediate delegator after being delegated. During delegation, the service provider 11 must receive and verify the attribute certificates of the service node and the service requestor 12. However, if the number of the service nodes becomes large, the service provider 11 will have to spend a considerable amount of computation resources on verification.

Referring to FIG. 2, U.S. Patent Application Publication No. 20040073801 disclosed a method for cascaded delegation. The method will be discussed hereinbelow using an example in which the method is used in a system including a service provider 21, two service nodes 22, 23, and a service requestor 24. The method includes the following steps:

the service provider 21 sends a first delegation token to the service node 22;

the service node 22 sends a response to the service provider 21;

the service provider 21 sends a first signature to the service node 22, the first signature including a signature of the first delegation token;

the service node 22 sends a second delegation token to the service node 23;

the service node 23 sends a response to the service node 22;

the service node 22 sends a second signature to the service node 23, the second signature including a signature of the second delegation token from the service node 22, and the first delegation token from the service provider 21 and the signature of the first delegation token;

the service node 23 sends a third delegation token to the service requestor 24;

the service requestor 24 sends a response to the service node 23; and

the service node 23 sends a third signature to the service requestor 24, the third signature including a signature of the third delegation token from the service node 23, the second delegation token from the service node 22 and the signature of the second delegation token, and the first delegation token from the service provider 21 and the signature of the first delegation token.

When the service requestor 24 wants to use the services provided by the service provider 21, the service requestor 24 must send the third signature to the service provider 21 for verification.

In the cascaded delegation method, since the delegation tokens of the service provider 21 and the service nodes 22, 23, and the signatures of the delegation tokens are cascaded to generate the signature for the service requestor 24, if the number of the service nodes is large, the signatures thus generated will be very long, so that not only will much network communication resources be wasted, the service provider 21 will also need to spend a considerable amount of computation resources on verification.

U.S. Patent Application Publication No. 20040117623 disclosed a method of initializing a secure communications link. Since this patent publication is similar to the aforesaid Patent Application Publication No. 20040073801 in concept, the same FIG. 2 and the same reference numerals will be used for illustration purposes. The method will be described using an example in which the method is used in a system including a service provider 21, two service nodes 22, 23, and a service requestor 24. The method includes the following steps:

the service provider 21 generates a first message, the first message including a first token and first authentication data, the first token including a first key and related first request data, the first authentication data including data generated using a secret key of the service provider 21 to operate on at least one of the first key and the first request data;

the service provider 21 uses a commonly known key shared with the service node 22 to encrypt the first message.

the service provider 21 sends the encrypted first message to the service node 22 to initialize a secure communications link;

the service node 22 uses a commonly known key shared with the service provider 21 to decrypt the encrypted first message;

the service node 22 generates a second message, the second message including a second token, second authentication data, the first token, and the first authentication data, the second token including a second key and related second request data, the second authentication data including data generated using a secret key of the service node 22 to operate on at least one of the second key and the second request data;

the service node 22 uses a commonly known key shared with the service node 23 to encrypt the second message;

the service node 22 sends the encrypted second message to the service node 23 to initialize a secure communications link;

the service node 23 uses a commonly known key shared with the service node 22 to decrypt the encrypted second message;

the service node 23 generates a third message, the third message including a third token, third authentication data, the second token, the second authentication data, the first token, and the first authentication data, the third token including a third key and related third request data, the third authentication data including data generated using a secret key of the service node 23 to operate on at least one of the third key and the third request data;

the service node 23 uses a commonly known key shared with the service requestor 24 to encrypt the third message;

the service node 23 sends the encrypted third message to the service requestor 24 to initialize a secure communications link; and

the service requestor 24 uses a commonly known key shared with the service node 23 to decrypt the encrypted third message.

When the service requestor 24 needs to use the services provided by the service provider 21, the service requestor 24 must send the third message to the service provider 21 for verification.

Since the method of initializing the secure communications link is to cascade the tokens and the authentication data of the service provider 21 and the service nodes 22, 23 to generate the message for the service requestor 24, if the number of the service nodes is large, the messages thus generated will be excessively long, so that not only will much network communication resources be wasted, the service provider 21 will also need to spend a considerable amount of computation resources on verification.

### DISCLOSURE OF INVENTION

Therefore, an object of the present invention is to provide a method for distributed delegation and verification, which can reduce the amount of data transmission and avoid overly large computation amount at a single point.

Another object of the present invention is to provide a system for distributed delegation and verification, which can reduce the amount of data transmission and avoid overly large computation amount at a single point.

A further object of the present invention is to provide an apparatus for distributed delegation and verification, which can reduce the amount of data transmission and avoid overly large computation amount at a single point.

Accordingly, the method for distributed delegation and verification of the present invention is adapted for use in a delegation chain including a service provider, a first service node, and a service requestor, and includes the following steps:

(A) the service provider generating first delegation information including authorization credentials and self-signed credentials thereof to establish a delegation relationship with the first service node;

(B) the first service node generating second delegation information including the authorization credentials in the first delegation information and self-signed credentials thereof to establish a delegation relationship with the service requestor;

(C) upon receipt from the service requestor of a service request including delegation information issued to the service requestor, the service provider requesting the first service node to verify the self-signed credentials in the delegation information in the service request;

(D) the first service node performing verification; and

(E) upon successful verification by the first service node, the service provider verifying the authorization credentials in the delegation information in the service request and, upon successful verification, granting the service request.

The system for distributed delegation and verification of the present invention includes a service provider, at least one service node, and a service requestor, which respectively act as a source delegator, an intermediary delegator and delegatee, and a destination delegatee.

The service provider generates first delegation information including authorization credentials and self-signed credentials thereof to establish a delegation relationship with a delegatee thereof, requests a delegator of the service requestor to verify the self-signed credentials in a service request, verifies the authorization credentials in the service request upon successful verification by the delegatee thereof, and grants the service request upon successful verification of the authorization credentials.

Each service node generates second delegation information including the authorization credentials in the first delegation information and self-signed credentials thereof to establish a delegation relationship with a delegatee thereof, verifies the self-signed credentials which it is requested to verify, and requests a delegator thereof to verify the self-signed credentials in the second delegation information issued thereto upon successful verification.

The service requestor submits to the service provider the service request including the delegation information issued thereto.

The apparatus for distributed delegation and verification of the present invention is adapted for use in a delegation chain including a service provider, at least one service node, and a service requestor, and includes a delegation unit and a verification unit.

The delegation unit establishes a delegation relationship with a delegator thereof and generates delegation information including authorization credentials and self-signed credentials to establish a delegation relationship with a delegatee thereof.

The verification unit verifies the self-signed credentials which it is requested to verify based on the delegation relationship established by the delegation unit.

### BRIEF DESCRIPTION OF DRAWINGS

Other features and advantages of the present invention will become apparent in the following detailed description of the preferred embodiment with reference to the accompanying drawings, of which:

FIG. 1 is a schematic diagram to illustrate a conventional method used in managing attribute certificates;

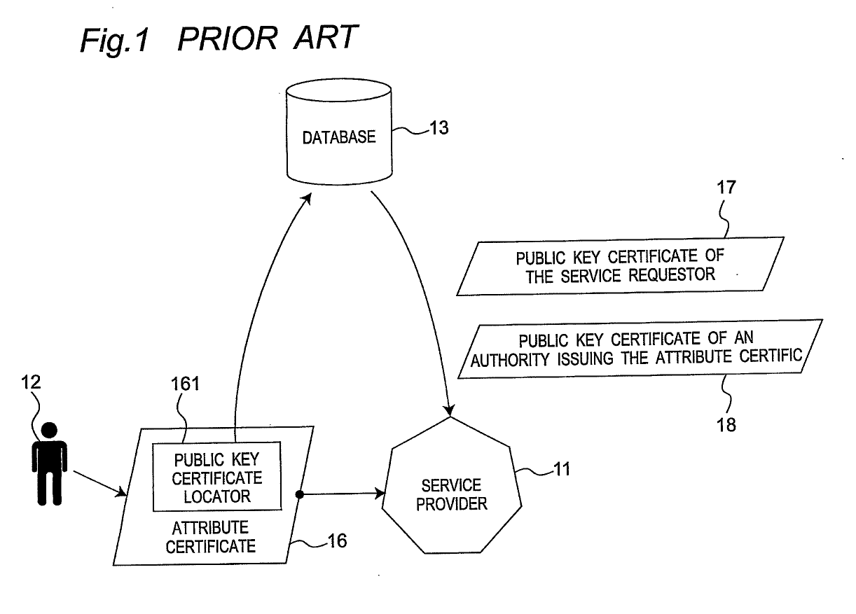

FIG. 2 is a schematic diagram to illustrate a conventional method of cascaded delegation and a conventional method of initializing a secure communications link;

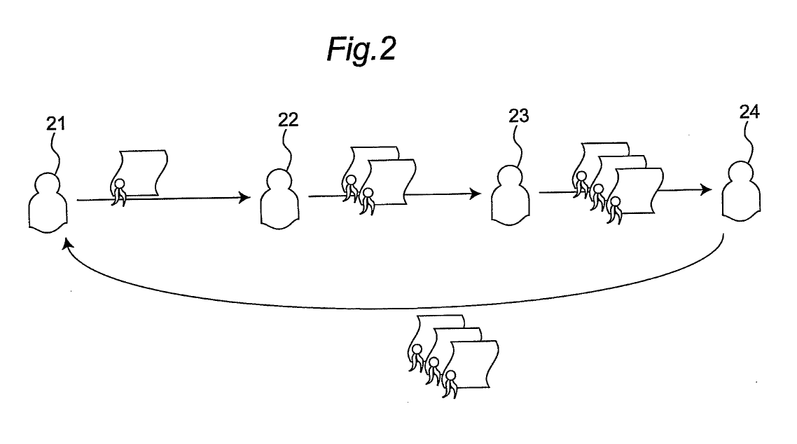

FIG. 3 is a flow diagram to illustrate a delegation procedure in a preferred embodiment of a method for distributed delegation and verification according to the present invention;

FIG. 4 is a flow diagram to illustrate a verification procedure in the method of the preferred embodiment;

FIG. 5 is a block diagram to illustrate a preferred embodiment of an apparatus for distributed delegation and verification according to the present invention;

FIG. 6 is a flow chart to illustrate a delegation operation when the apparatus is installed at a service provider;

FIG. 7 is a flow chart to illustrate a verification operation when the apparatus is installed at the service provider;

FIG. 8 is a flow chart to illustrate a delegation accepting operation when the apparatus is installed at a service node;

FIG. 9 is a flow chart to illustrate a delegation operation when the apparatus is installed at a service node;

FIG. 10 is a flow chart to illustrate a verification operation when the apparatus is installed at the service node;

FIG. 11 is a schematic diagram to illustrate an abnormal delegation procedure in the preferred embodiment of the method for distributed delegation and verification according to the present invention; and

FIG. 12 is a schematic diagram to illustrate a verification procedure to prevent abnormal delegation in the preferred embodiment of the method for distributed delegation and verification according to the present invention.

### BEST MODE FOR CARRYING OUT THE INVENTION

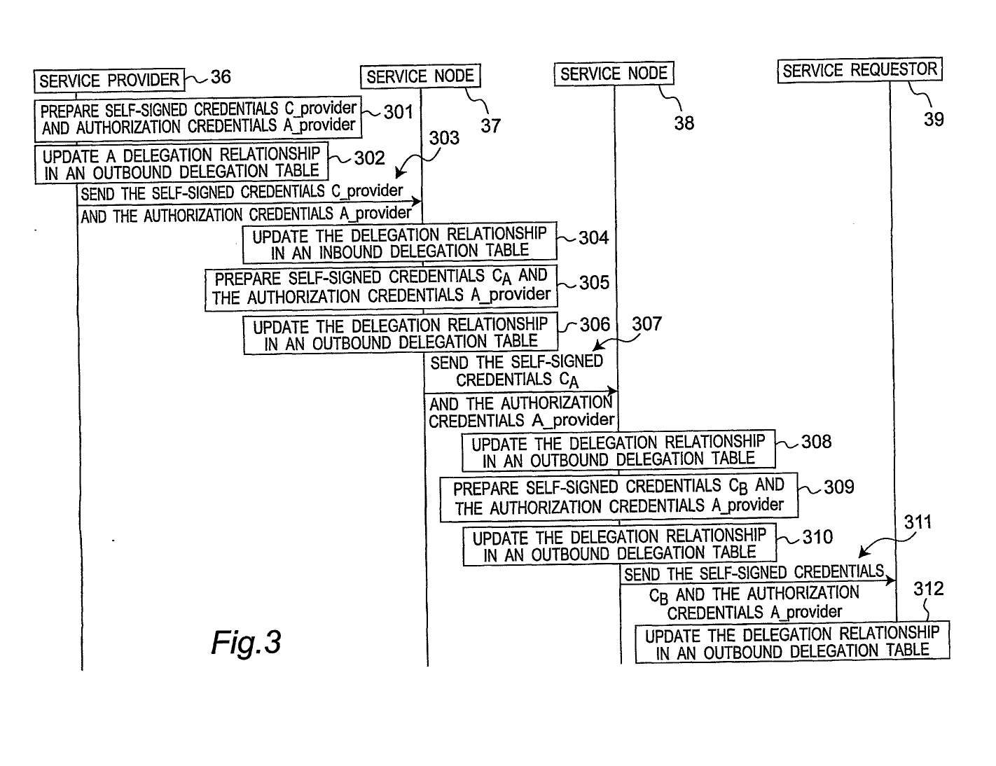

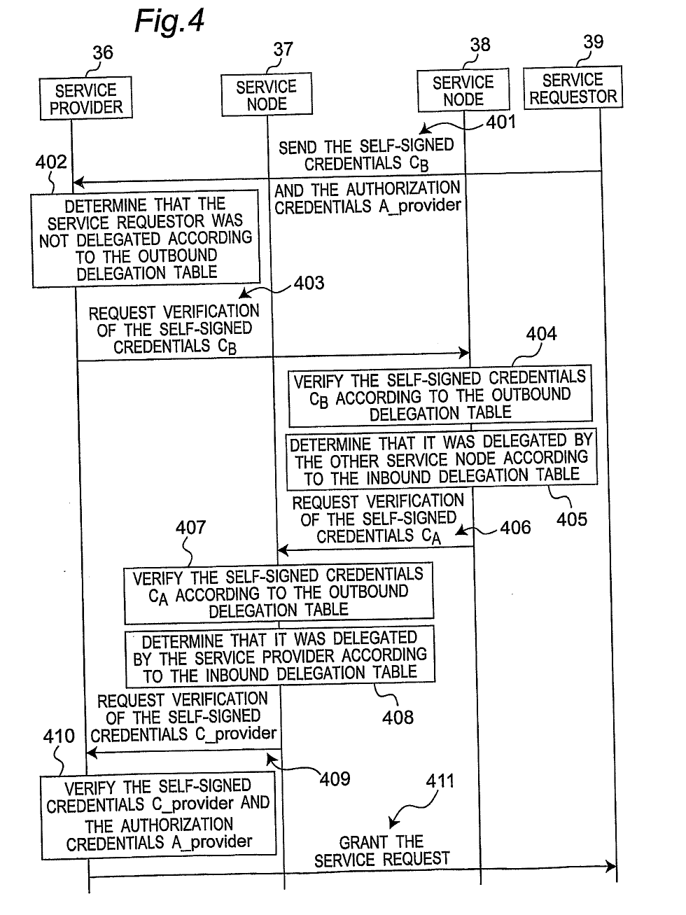

Referring to FIGS. 3 and 4, the preferred embodiment of a method for distributed delegation and verification according to the present invention is adapted for use in a delegation chain including a service provider 36, a service requestor 39, and at least one service node. The service provider 36 is a source delegator. The service requestor 39 is a destination delegatee. The service node first acts as an intermediary delegatee and then as an intermediary delegator after being delegated by a delegator. When the service requestor 39 requests the service provider 36 to provide services, the service provider 36 asks the service node to help verify the delegation to the service requestor 39. The method includes a delegation procedure and a verification procedure, which will be exemplified below by means of a delegation chain including two service nodes 37, 38.

The delegation procedure includes the following steps:

In step 301, the service provider 36 generates first delegation information.

In this embodiment, the delegation information includes self-signed credentials of the delegator, and authorization credentials related to the permitted services. The authorization credentials are generated by the source delegator. Therefore, in step 301, the first delegation information includes the self-signed credentials C_provider of the service provider 36, and the authorization credentials A_provider generated by the service provider 36.

In step 302, the service provider 36 updates the delegation relationship recorded in an outbound delegation table thereof.

In this embodiment, the outbound delegation table contains an identifier of a delegator, an identifier of a delegatee, an identifier of a source delegator, and the delegation information generated by the delegator. Therefore, in step 302, the outbound delegation table contains an identifier of the service provider 36, an identifier of the service node 37, an identifier of the service provider 36, the self-signed credentials C_provider of the service provider 36, and the authorization credentials A_provider generated by the service provider 36.

In step 303, the service provider 36 sends the first delegation information thus generated to the service node 37 (which acts as an intermediary delegatee at this point).

In step 304, the service node 37 updates the delegation relationship recorded in an inbound delegation table thereof.

In this embodiment, the inbound delegation table contains the identifier of the delegator, the identifier of the delegatee, the identifier of the source delegator, and the delegation information generated by the delegator. Therefore, in step 304, the inbound delegation table contains the identifier of the service provider 36, the identifier of the service node 37, the identifier of the service provider 36, the self-signed credentials C_provider of the service provider 36, and the authorization credentials A_provider generated by the service provider 36.

The service provider 36 establishes a delegation relationship with the service node 37 through the aforesaid steps 301 to 304.

In step 305, the service node 37 (which acts as an intermediary delegator at this point) generates second delegation information. In this step, the second delegation information includes the self-signed credentials CA of the service node 37, and the authorization credentials A_provider generated by the service provider 36.

In step 306, the service node 37 updates the delegation relationship stored in an outbound delegation table thereof. In this step, the outbound delegation table contains the identifier of the service node 37, an identifier of the service node 38, the identifier of the service provider 36, the self-signed credentials CA of the service node 37, and the authorization credentials A_provider generated by the service provider 36.

In step 307, the service node 37 sends the second delegation information thus generated to the service node 38 (which acts as an intermediary delegatee at this point).

In step 308, the service node 38 updates the delegation relationship recorded in an inbound delegation table thereof. In this step, the inbound delegation table contains the identifier of the service node 37, the identifier of the service node 38, the identifier of the service provider 36, the self-signed credentials CA of the service node 37, and the authorization credentials A_provider generated by the service provider 36.

The service node 37 establishes a delegation relationship with the service node 38 through the aforesaid steps 305 to 308.

In step 309, the service node 38 (which acts as an intermediary delegator at this point) generates third delegation information. In this step, the third delegation information includes the self-signed credentials CB of the service node 38, and the authorization credentials A_provider generated by the service provider 36.

In step 310, the service node 38 updates the delegation relationship recorded in an outbound delegation table thereof. In this step, the outbound delegation table contains the identifier of the service node 38, the identifier of the service requestor 39, the identifier of the service provider 36, the self-signed credentials CB of the service node 38, and the authorization credentials A_provider generated by the service provider 36.

In step 311, the service node 38 sends the third delegation information thus generated to the service requestor 39.

In step 312, the service requestor 39 updates the delegation relationship recorded in an inbound delegation table thereof. In this step, the inbound delegation table contains the identifier of the service node 38, the identifier of the service requestor 39, the identifier of the service provider 36, the self-signed credentials CB of the service node 38, and the authorization credentials A_provider generated by the service provider 36.

The service node 38 establishes a delegation relationship with the service requestor 39 through the aforesaid steps 309 to 312.

The verification procedure includes the following steps:

In step 401, the service requestor 39 submits to the service provider 36 a service request including the delegation information issued thereto. In this step, the delegation information includes the self-signed credentials CB of the service node 38 and the authorization credentials A_provider generated by the service provider 36.

In step 402, the service provider 36 determines that the service requestor 39 was not delegated according to the delegation relationship stored in the outbound delegation table thereof (i.e., determining that the identifier of the delegatee in the outbound delegation table is different from the identifier of the service requestor 39).

In step 403, the service provider 36 requests the service node 38 to verify the self-signed credentials in the delegation information in the service request. In this step, the self-signed credentials are the self-signed credentials CB of the service node 38.

In step 404, the service node 38 utilizes the delegation relationship stored in the outbound delegation table thereof to verify the self-signed credentials which it is requested to verify.

In this embodiment, the service node 38 determines whether the self-signed credentials requiring verification are the same as the self-signed credentials stored in the outbound delegation table thereof (i.e., determining whether the self-signed credentials requiring verification are the same as the self-signed credentials thereof) and whether the identifier of the delegatee in the outbound delegation table is the same as the identifier of the service requestor 39 (i.e., determining whether there is a delegation relationship between the service requestor 39 and itself).

In step 405, the service node 38 utilizes the delegation relationship stored in the inbound delegation table thereof to determine that it was delegated by the service node 37.

In step 406, the service node 38 requests the service node 37 to verify the self-signed credentials in the second delegation information issued thereto. In this step, the self-signed credentials are the self-signed credentials CA of the service node 37.

In step 407, the service node 37 utilizes the delegation relationship stored in the outbound delegation table thereof to verify the self-signed credentials which it is requested to verify.

In this embodiment, the service node 37 determines whether the self-signed credentials which it is requested to verify are the same as the self-signed credentials in the outbound delegation table thereof (i.e., determining whether the self-signed credentials which it is requested to verify are the same as the self-signed credentials thereof) and whether the identifier of the delegatee in the outbound delegation table is the same as the identifier of the service node 38 (i.e., determining whether there is a delegation relationship between the service node 38 and itself).

In step 408, the service node 37 utilizes the delegation relationship stored in the inbound delegation table thereof to determine that it was delegated by the service provider 36.

In step 409, the service node 37 requests the service provider 36 to verify the self-signed credentials in the first delegation information issued thereto. In this step, the self-signed credentials are the self-signed credentials C_provider of the service provider 36.

In step 410, the service provider 36 utilizes the delegation relationship stored in the outbound delegation table thereof to verify the self-signed credentials which it is requested to verify, and the authorization credentials in the delegation information in the service request.

In this embodiment, the service provider 36 determines whether the self-signed credentials which it is requested to verify and the authorization credentials in the delegation information in the service request are the same as the self-signed credentials and the authorization credentials in the outbound delegation table thereof (i.e., determining whether the self-signed credentials which it is requested to verify are the same as the self-signed credentials thereof, and whether the authorization credentials in the delegation information in the service request are the same as the authorization credentials thus generated) and whether the identifier of the delegatee in the outbound delegation table thereof is the same as the identifier of the service node 37 (i.e., determining whether there is a delegation relationship between the service node 37 and itself).

In step 411, the service provider 36 grants the service request submitted by the service requestor 39.

Although the method for distributed delegation and verification according to the present invention is adapted for use in a delegation chain including a service provider 36, a service requestor 39, and at least one service node, it may also be adapted for use in a scenario where there is only one service provider and one service requestor.

The above description is directed to how the service provider 36, the service nodes 37, 38, and the service requestor 39 operate with respect to each other. The apparatus employed by the service provider 36 and the service nodes 37, 38, as well as the operational flow thereof, will be described in detail hereinbelow.

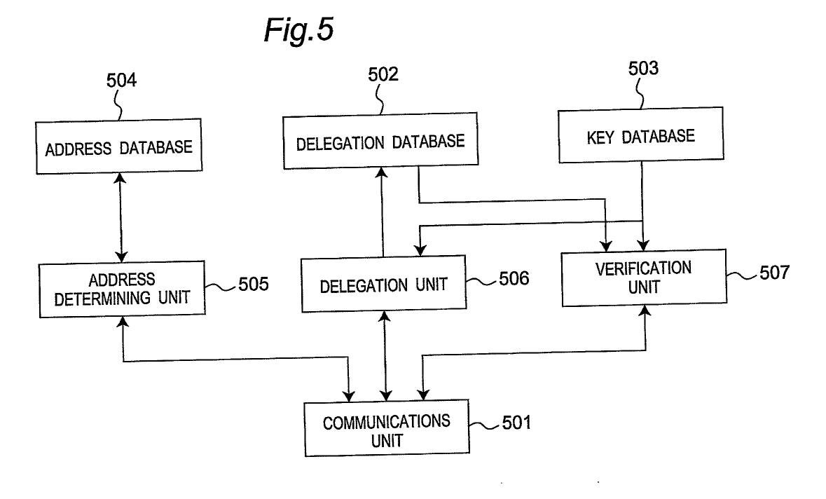

Referring to FIG. 5, an apparatus for distributed delegation and verification employed by each of the service provider 36 and the service nodes 37, 38 includes a communications unit 501, a delegation database 502, a key database 503, an address database 504, an address determining unit 505, a delegation unit 506, and a verification unit 507.

The communications unit 501 is used to transmit and receive data to and from the outside.

The delegation database 502 stores at least one of an outbound delegation table and an inbound delegation table for recording delegation relationships.

The key database 503 stores at least one key.

The address database 504 stores address information of other apparatuses in the delegation chain having a direct delegating or delegated relationship with the apparatus.

The address determining unit 505 is used to update the address database 504, and to determine from the address database 504 the address information required by the verification unit 507.

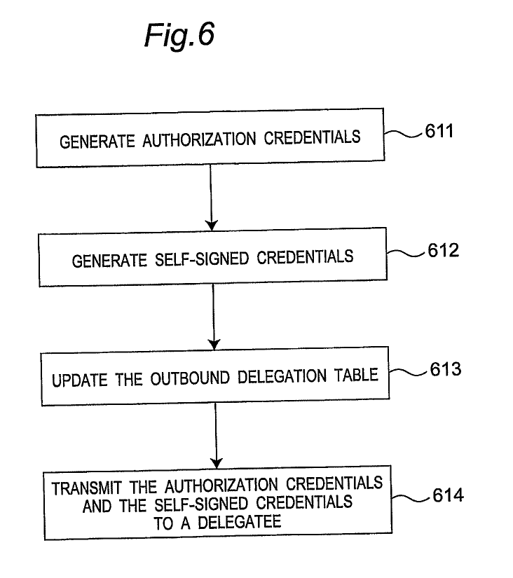

Referring to FIGS. 5 and 6, when the apparatus for distributed delegation and verification is installed at the service provider 36, the operational flow of the delegation unit 506 during the delegation procedure includes the following steps:

In step 611, authorization credentials are generated.

In step 612, self-signed credentials of the service provider 36 are generated according to the key stored in the key database 503 using a symmetrical or asymmetrical cryptographic technique.

In step 613, the outbound delegation table stored in the delegation database 502 is updated. At this time, the address determining unit 505 updates the address database 504.

In step 614, the authorization credentials and the self-signed credentials are transmitted to a delegatee of the service provider 36 through the communications unit 501.

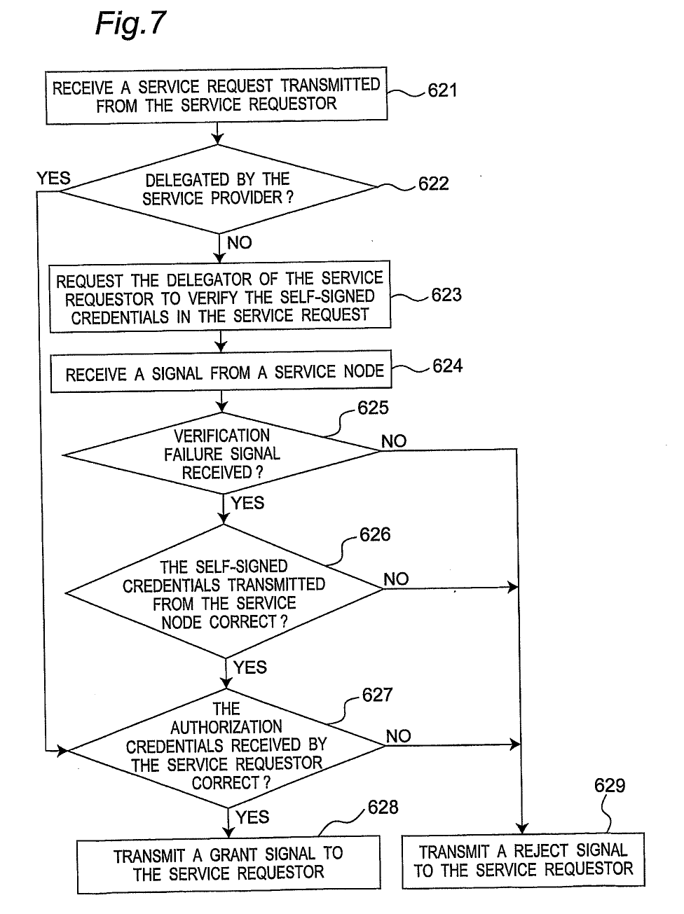

Referring to FIGS. 5 and 7, when the apparatus for distributed delegation and verification is installed at the service provider 36, the operational flow of the verification unit 507 includes the following steps:

In step 621, a service request transmitted from the service requestor 39 and including issued self-signed credentials and authorization credentials is received through the communications unit 501. The flow then goes to step 622.

In step 622, a determination is made as to whether the service requestor 39 was delegated by the service provider 36 according to the outbound delegation table stored in the delegation database 502. The flow goes to step 627 if yes. The flow goes to step 623 if no.

In step 623, the delegator of the service requestor 39 is requested to verify the self-signed credentials in the service request through the communications unit 501. At this time, the address determining unit 505 determines the address information of the delegator of the service requestor 39. The flow then goes to step 624.

In step 624, a signal is received from a service node through the communications unit 501 (which may be a verification failure signal or self-signed credentials received by the service node upon being delegated). The flow then goes to step 625.

In step 625, a determination is made as to whether a verification failure signal is received. The flow goes to step 629 if yes. The flow goes to step 626 if no.

In step 626, the correctness of the self-signed credentials received in step 624 is verified according to the outbound delegation table stored in the delegation database 502. The flow goes to step 627 if yes. The flow goes to step 629 if no.

In step 627, the correctness of the authorization credentials received in step 621 is verified according to the outbound delegation table stored in the delegation database 502. The flow goes to step 628 if yes. The flow goes to step 629 if no.

In step 628, a grant signal is transmitted to the service requestor 39 through the communications unit 501.

In step 629, a reject signal is transmitted to the service requestor 39 through the communications unit 501.

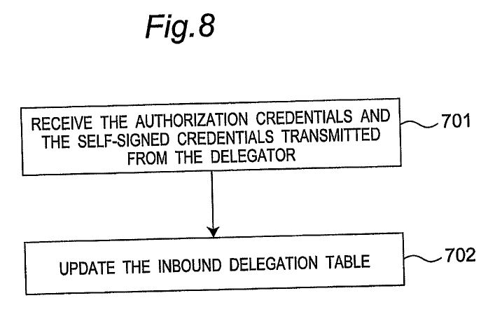

Referring to FIGS. 5 and 8, when the apparatus for distributed delegation and verification is installed at the service nodes 37, 38, the operational flow of the delegation unit 506 during a delegation accepting operation includes the following steps:

In step 701, the authorization credentials and the self-signed credentials transmitted from the delegator thereof are received through the communications unit 501.

In step 702, the inbound delegation table stored in the delegation database 502 is updated. At this time, the address determining unit 505 updates the address database 504.

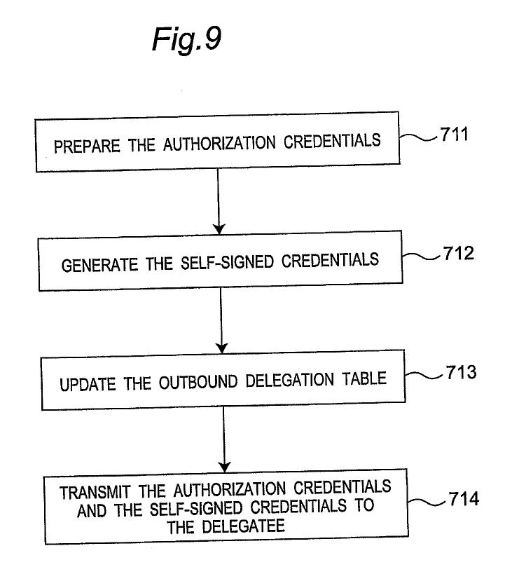

Referring to FIGS. 5 and 9, when the apparatus for distributed delegation and verification is installed at the service nodes 37, 38, the operational flow of the delegation unit 506 during the delegation procedure includes the following steps:

In step 711, the authorization credentials generated by the service provider 36 are prepared.

In step 712, the self-signed credentials of the service node are generated according to the key stored in the key database 503 using a symmetrical or asymmetrical cryptographic technique.

In step 713, the outbound delegation table stored in the delegation database 502 is updated. At this time, the address determining unit 505 updates the address database 504.

In step 714, the authorization credentials and the self-signed credentials are transmitted to the delegatee of the service node through the communications unit 501.

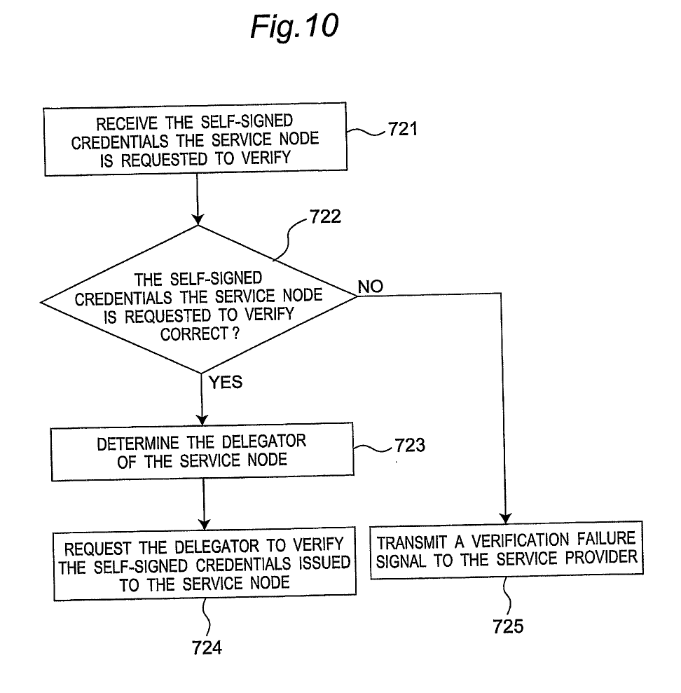

Referring to FIGS. 5 and 10, when the apparatus for distributed delegation and verification is installed at the service nodes 37, 38, the operational flow of the verification unit 507 includes the following steps:

In step 721, the self-signed credentials which the service node is requested to verify is received through the communications unit 501. The flow goes to step 722.

In step 722, the correctness of the self-signed credentials received in step 721 is verified according to the outbound delegation table stored in the delegation database 502. The flow goes to step 723 if yes. The flow goes to step 725 if no.

In step 723, the delegator of the service node is determined according to the inbound delegation table stored in the delegation database 502. The flow goes to step 724.

In step 724, the delegator of the service node is requested to verify the self-signed credentials issued to the service node through the communications unit 501. At this time, the address determining unit 505 determines the address information of the delegator of the service node.

In step 725, a verification failure signal is transmitted to the service provider 36 through the communications unit 501. At this time, the address determining unit 505 determines the address information of the service provider 36.

It is noted that, in steps 403 and 623, the service provider 36 may determine that the delegation information in the service request was issued by the service node 38 through a point-to-point inquiry service. The service provider 36 then requests the service node 38 to verify the self-signed credentials in the service request. Alternatively, the service provider 36 may request the service node 37 to verify the self-signed credentials in the service request based on the delegation relationship established therewith. The service node 37 proceeds with the verification and, if unable to verify, requests the service node 38 to verify the self-signed credentials in the service request based on the delegation relationship established therewith.

In step 725, the service nodes 37, 38 may find out the address information of the service provider 36 through a point-to-point inquiry service, and then transmit a verification failure signal to the service provider 36. Alternatively, the service nodes 37, 38 may transmit the verification failure signal to the delegator thereof based on the delegation relationship established therewith. The delegator in turn transmits the verification failure signal to the delegator thereof based on the delegation relationship established therewith. This process is repeated to transmit the verification failure signal to the service provider 36. For instance, the service node 38 transmits the verification failure signal to the service node 37 based on the delegation relationship established therewith, and the service node 37 then transmits the verification failure signal to the service provider 36 based on the delegation relationship established therewith.

The system for distributed delegation and verification according to the present invention includes the aforesaid service provider 36, the service nodes 37, 38, and the service requestor 39.

A simple example is provided hereinbelow to illustrate how secure service sharing can be achieved in the present invention.

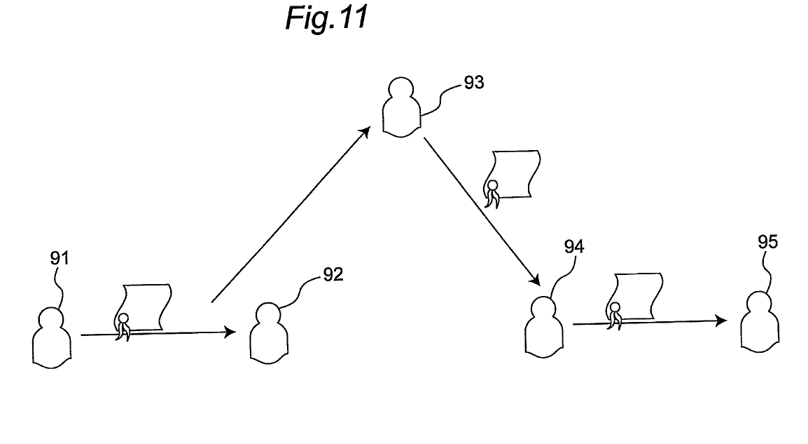

Referring to FIG. 11, a service provider 91 generates first delegation information including authorization credentials and self-signed credentials thereof to establish a delegation relationship with a service node 92. A service node 93 steals the first delegation information, and generates second delegation information including the authorization credentials in the first delegation information and self-signed credentials thereof to establish a delegation relationship with a service node 94. The service node 94 generates third delegation information including the authorization credentials in the second delegation information and self-signed credentials thereof to establish a delegation relationship with a service requestor 95.

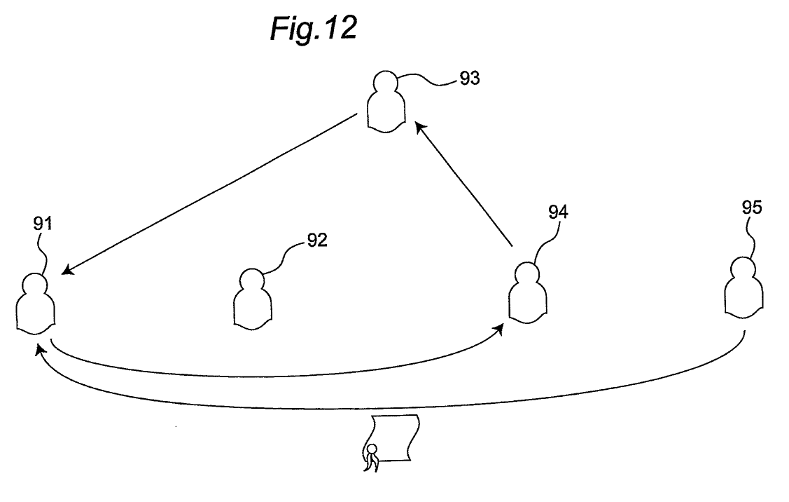

Referring to FIG. 12, the service requestor 95 submits to the service provider 91 a service request including the delegation information (i.e., the third delegation information) issued thereto. The service provider 91 requests the service node 94 to verify the self-signed credentials in the delegation information in the service request. The service node 94 performs the verification and, upon successful verification, requests the service node 93 to verify the self-signed credentials in the second delegation information. The service node 93 performs the verification and, upon successful verification, requests the service provider 91 to verify the self-signed credentials in the first delegation information. The service provider 91 performs the verification according to the outbound delegation table thereof, and confirms that there is no delegation relationship between itself and the service node 93 (because the identifier of the service node 93 is not recorded in the outbound delegation table of the service provider 91). The service provider 91 therefore rejects the service request submitted by the service requestor 95.

In sum, since every piece of delegation information only includes the self-signed credentials of the delegator and the authorization credentials related to the permitted services, and will not lengthen with an increase in the number of the service nodes, the amount of transmitted data can be reduced. Furthermore, since the self-signed credentials in every piece of delegation information are verified by the generator of the delegation information, heavy computation load on the service provider can be avoided. Thus, compared with the prior art, the present invention can indeed achieve the intended objects.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

### INDUSTRIAL APPLICABILITY

The present invention can be applied to a method, apparatus and system for distributed delegation and verification.

1. A method for distributed delegation and verification adapted for use in a delegation chain including a service provider, a first service node, and a service requestor, said method comprising the following steps:
(A) the service provider generating first delegation information including authorization credentials and self-signed credentials thereof to establish a delegation relationship with the first service node;
(B) the first service node generating second delegation information including the authorization credentials in the first delegation information and self-signed credentials thereof to establish a delegation relationship with the service requestor;
(C) upon receipt from the service requestor of a service request including delegation information issued to the service requestor, the service provider requesting the first service node to verify the self-signed credentials in the delegation information in the service request;
(D) the first service node performing verification; and
(E) upon successful verification by the first service node, the service provider verifying the authorization credentials in the delegation information in the service request and, upon successful verification, granting the service request.

2. The method for distributed delegation and verification according to claim 1, wherein the first service node determines whether the self-signed credentials which it is requested to verify are the same as the self-signed credentials thereof based on the established delegation relationship.

3. The method for distributed delegation and verification according to claim 2, wherein, in step (D), upon successful verification, the first service node requests the service provider to verify the self-signed credentials in the first delegation information, and in step (E), the service provider further determines whether the self-signed credentials which it is requested to verify are the same as the self-signed credentials thereof based on the established delegation relationship.

4. The method for distributed delegation and verification according to claim 1, wherein the delegation chain further includes a second service node, and wherein, in step (B), the first service node first establishes a delegation relationship with the second service node using the second delegation information, and the second service node further generates third delegation information including the authorization credentials in the second delegation information and self-signed credentials thereof to establish a delegation relationship with the service requestor, and in step (C), the service provider first requests the second service node to verify the self-signed credentials in the delegation information in the service request, and the second service node performs the verification and, upon successful verification, requests the first service node to verify the self-signed credentials in the second delegation information.

5. The method for distributed delegation and verification according to claim 4, wherein, in step (C), the service provider requests the second service node to verify the self-signed credentials in the delegation information in the service request in the following manner: the service provider first requests the first service node to verify the self-signed credentials in the delegation information in the service request based on the delegation relationship established therewith, and the first service node performs the verification and, when unable to verify, requests the second service node to verify the self-signed credentials in the delegation information in the service request based on the delegation relationship established therewith.

6. The method for distributed delegation and verification according to claim 4, wherein, in step (C), the service provider requests the second service node to verify the self-signed credentials in the delegation information in the service request in the following manner: the service provider first uses a point-to-point inquiry service to find out that the delegation information in the service request was signed and issued by the second service node and then requests the second service node to verify the self-signed credentials in the delegation information in the service request.

7. The method for distributed delegation and verification according to claim 4, wherein each of the service nodes determines whether the self-signed credentials which it is requested to verify are the same as the self-signed credentials thereof based on the established delegation relationship.

8. A system for distributed delegation and verification, comprising:
a service provider, at least one service node, and a service requestor which respectively act as a source delegator, an intermediary delegatee and delegator, and a destination delegatee;
the service provider generating first delegation information including authorization credentials and self-signed credentials thereof to establish a delegation relationship with a delegatee thereof, requesting a delegator of the service requestor to verify the self-signed credentials in a service request, verifying the authorization credentials in the service request upon successful verification by the delegatee thereof, and granting the service request upon successful verification of the authorization credentials;
said at least one service node generating second delegation information including the authorization credentials in the first delegation information and self-signed credentials thereof to establish a delegation relationship with a delegatee thereof, verifying the self-signed credentials which it is requested to verify, and requesting a delegator thereof to verify the self-signed credentials in the second delegation information issued thereto upon successful verification;
the service requestor submitting to the service provider the service request including the delegation information issued thereto

9. The system for distributed delegation and verification according to claim 8, wherein said at least one service node determines whether the self-signed credentials which it is requested to verify are the same as the self-signed credentials thereof based on the established delegation relationship.

10. The system for distributed delegation and verification according to claim 9, wherein the delegatee of the service provider further requests the service provider to verify the self-signed credentials in the first delegation information upon successful verification, the service provider further determining whether the self-signed credentials which it is requested to verify are the same as the self-signed credentials thereof based on the established delegation relationship.

11. The system for distributed delegation and verification according to claim 8, wherein the service provider requests the delegator of the service requestor to verify the self-signed credentials in the service request in the following manner: the service provider requests the delegatee thereof to verify the self-signed credentials in the service request based on the delegation relationship established therewith, said at least one service node verifying the self-signed credentials in the service request and, when unable to verify, requesting the delegatee thereof to verify the self-signed credentials in the service request based on the delegation relationship established therewith.

12. The system for distributed delegation and verification according to claim 8, wherein the service provider finds out the delegator of the service requestor using a point-to-point inquiry service.

13. An apparatus for distributed delegation and verification adapted for use in a delegation chain including a service provider, at least one service node, and a service requestor, said apparatus comprising:
a delegation unit which establishes a delegation relationship with a delegator thereof and which generates delegation information including authorization credentials and self-signed credentials to establish a delegation relationship with a delegatee thereof; and
a verification unit which verifies the self-signed credentials which it is requested to verify based on the delegation relationship established by said delegation unit.

14. The apparatus for distributed delegation and verification according to claim 13, further comprising a key database storing at least one key, said delegation unit generating the self-signed credentials according to said key in said key database and using one of symmetrical and asymmetrical cryptographic techniques.

15. The apparatus for distributed delegation and verification according to claim 13, further comprising a delegation database storing at least one of an outbound delegation table and an inbound delegation table, said outbound delegation table being used to record the delegation relationship with the delegatee thereof, said inbound delegation table being used to record the delegation relationship with the delegator thereof.

16. The apparatus for distributed delegation and verification according to claim 13, further comprising an address determining unit, said address determining unit storing and determining address information of the delegatee thereof and the delegator thereof based on the delegation relationships established by said delegation unit.

17. The apparatus for distributed delegation and verification according to claim 13, wherein, when said apparatus is installed at the service provider, said delegation unit generates first delegation information including authorization credentials and self-signed credentials of the service provider to establish the delegation relationship with the delegatee thereof, and said verification unit requests the delegator of the service requestor to verify the self-signed credentials in a service request including the delegation information issued to the service requestor, verifies the authorization credentials in the service request upon successful verification by the delegatee thereof, and grants the service request upon successful verification of the authorization credentials.

18. The apparatus for distributed delegation and verification according to claim 17, wherein said verification unit further verifies the self-signed credentials that is requested to be verified by the delegatee thereof.

19. The apparatus for distributed delegation and verification according to claim 18, wherein said verification unit determines whether the self-signed credentials which it is requested to verify are the same as the self-signed credentials of the service provider based on the delegation relationship established by said delegation unit.

20. The apparatus for distributed delegation and verification according to claim 17, wherein said verification unit of the service provider requests the delegator of the service requestor to verify the self-signed credentials in the service request in the following manner: said verification unit requests the delegatee thereof to verify the self-signed credentials in the service request based on the delegation relationship established by said delegation unit.

21. The apparatus for distributed delegation and verification according to claim 17, wherein said verification unit of the service provider finds out the delegator of the service requestor using a point-to-point inquiry service.

22. The apparatus for distributed delegation and verification according to claim 13, wherein, when said apparatus is installed at the service node, said delegation unit generates second delegation information including the authorization credentials in first delegation information and the self-signed credentials of the service node to establish the delegation relationship with the delegatee thereof, the first delegation information including the authorization credentials and the self-signed credentials of the service provider, and said verification unit verifies the self-signed credentials which it is requested to verify by the delegatee thereof, and requests the delegator thereof to verify the self-signed credentials in the second delegation information issued by the delegator thereof upon successful verification.

23. The apparatus for distributed delegation and verification according to claim 22, wherein said verification unit determines whether the self-signed credentials which it is requested to verify are the same as the self-signed credentials of the service node based on the delegation relationship established by said delegation unit.

24. The apparatus for distributed delegation and verification according to claim 22, wherein, when said apparatus is installed in a delegatee of the service provider, said verification unit further requests the service provider to verify the self-signed credentials in the first delegation information upon successful verification.

25. The apparatus for distributed delegation and verification according to claim 22, wherein said verification unit further verifies the self-signed credentials in the service request which it is requested to verify by the delegator thereof, and, when unable to verify, requests a delegatee thereof to verify the self-signed credentials in the service request based on the delegation relationship established by said delegation unit.
